(19) United States
(12) Patent Application Publication
(10) Pub. No.: US 2015/0253492 A1
(43) Pub. Date: Sep. 10, 2015

(54) LIGHTING APPARATUS AND DISPLAY APPARATUS

(71) Applicants: Kabushiki Kaisha Toshiba, Tokyo (JP); Toshiba Lifestyle Products & Services Corporation, Tokyo (JP)

(72) Inventor: Takahisa Kaihotsu, Musashino Tokyo (JP)

(21) Appl. No.: 14/598,771

(22) Filed: Jan. 16, 2015

Related U.S. Application Data
(60) Provisional application No. 61/948,380, filed on Mar. 5, 2014.

(51) Int. Cl. F21V 8/00

(52) U.S. Cl. CPC G02B 6/0045; G02B 6/0091; G02B 6/0073; G02B 6/0028

(57) ABSTRACT

An embodiment provides a lighting apparatus including a flexible first light guide member having a rectangular shape with at least one corner chipped, and a first light source that is disposed at a position of the chipped corner of the first light guide member and emits light to the first light guide member.

### CROSS-REFERENCE TO RELATED APPLICATIONS

This application is based upon and claims the benefit of priority from U.S. Provisional Application No. 61/948,380, filed Mar. 5, 2014; the entire contents of which are incorporated herein by reference.

### FIELD

An embodiment relates to a lighting apparatus and a display apparatus.

### BACKGROUND

Conventionally, a flexible display apparatus using an organic light emitting diode (OLED) has been developed. However, the OLED has problems such as a high manufacturing cost and a short life, which has recently led to a proposal to a flexible liquid crystal display apparatus.

A liquid crystal element is not self-luminous, and hence the liquid crystal display apparatus requires a lighting apparatus (backlight unit) for illuminating a liquid crystal display panel from the behind. The lighting apparatus also needs to be flexible. As such a lighting apparatus, there is known a lighting apparatus configured such that a board (LED bar) having a light emitting diode (LED) light source disposed thereon, is disposed on a side of a flexible light guide plate.

However, the LED bar is not flexible. Accordingly the lighting apparatus can be bent in a direction parallel to a side where the LED bar is disposed, but cannot be bent in a direction perpendicular thereto, which restricts bending flexibility.

### BRIEF DESCRIPTION OF THE DRAWINGS

FIG. 1 is a plan view as seen from above of a main portion of a lighting apparatus 10 according to a first embodiment;

FIG. 2 is an explanatory view explaining bending flexibility of the lighting apparatus 10;

FIG. 3 is another explanatory view explaining bending flexibility of the lighting apparatus 10;

FIG. 4 is a side view as viewed from the side of the lighting apparatus 10;

FIG. 5 is an explanatory view explaining the energy of light emitted by an LED light source 2;

FIGS. 6A to 6C each are an explanatory view explaining the energy of light emitted by an LED light source 2;

FIG. 7 is a plan view as seen from above of a modification of the lighting apparatus 10;

FIG. 8 is a plan view as seen from above of a main portion of a lighting apparatus 10a according to a second embodiment;

FIG. 9 is a plan view as seen from above of a main portion of a lighting apparatus 10b;

FIG. 10 is a plan view as seen from above of a main portion of a lighting apparatus 10c;

FIG. 11 is a side view as viewed from the side of a liquid crystal display apparatus 100 using the lighting apparatus 10; and

FIG. 12 is a plan view as seen from above of a main portion of a display system 200 configured to tile a plurality of lighting apparatuses 10b and liquid crystal display panels 31.

### DETAILED DESCRIPTION

An embodiment provides a lighting apparatus including a flexible first light guide member having a rectangular shape with at least one corner chipped; and a first light source that is disposed at a position of the chipped corner of the first light guide member and emits light to the first light guide member.

Hereinafter, embodiments will be described in detail with reference to the accompanying drawings.

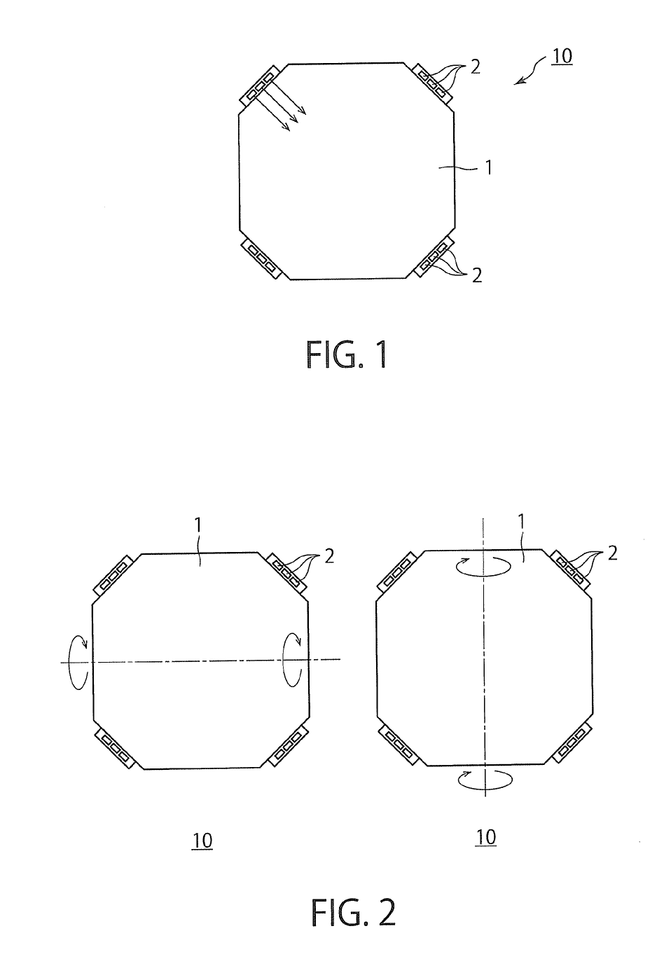

FIG. 1 is a plan view as seen from above of a main portion of a lighting apparatus 10 according to a first embodiment. The lighting apparatus 10 includes a light guide plate (first light guide member) 1 and an LED light source (light source) 2. The LED light source 2 emits light to the light guide plate 1. The light is spread within the light guide plate 1 and emitted from an entire upper surface of the light guide plate 1, whereby a surface light source is implemented. The lighting apparatus 10 can be used, for example, as a backlight unit for the liquid crystal display apparatus.

The light guide plate 1 is a flexible sheet made of urethane, soft acrylic resin, or the like, and thus has a high flexibility. In addition, the light guide plate 1 desirably has a high transparency to light of any wavelength. The light guide plate 1 has a rectangular shape with at least one corner chipped. As an example, the light guide plate 1 has a square shape of 225 mm on a side with the four corners cut in a straight line. The light guide plate 1 may be obtained by forming the above materials into a shape illustrated in FIG. 1, or the light guide plate 1 may be obtained by cutting the corners of a rectangular light guide plate.

A scattering mark (unillustrated) for extracting light is formed on an upper surface and/or a lower surface of the light guide plate 1 using white ink. If the light guide plate 1 is weak to heat, the scattering mark is desirably formed by ink jet printing without the need of baking. The scattering mark is designed so that the lighting apparatus 10 emits uniform light upward. For example, the scattering marks are provided such that the farther away from the LED light source 2 is, the higher the density is.

The LED light source 2 is disposed at a position of each chipped corner of the light guide plate 1. Then, the LED light source 2 emits light diagonally toward the center from an edge of the light guide plate 1 in the same plane as the light guide plate 1. The LED light source 2 desirably emits light perpendicularly to the edge. The LED light source 2 may be configured of only white LED to suppress cost, or may be configured of LEDs for emitting light at each wavelength of RGB to enhance the expressive power of colors. Note that the LED light source 2 may be of a side-view type or may be of a top-view type.

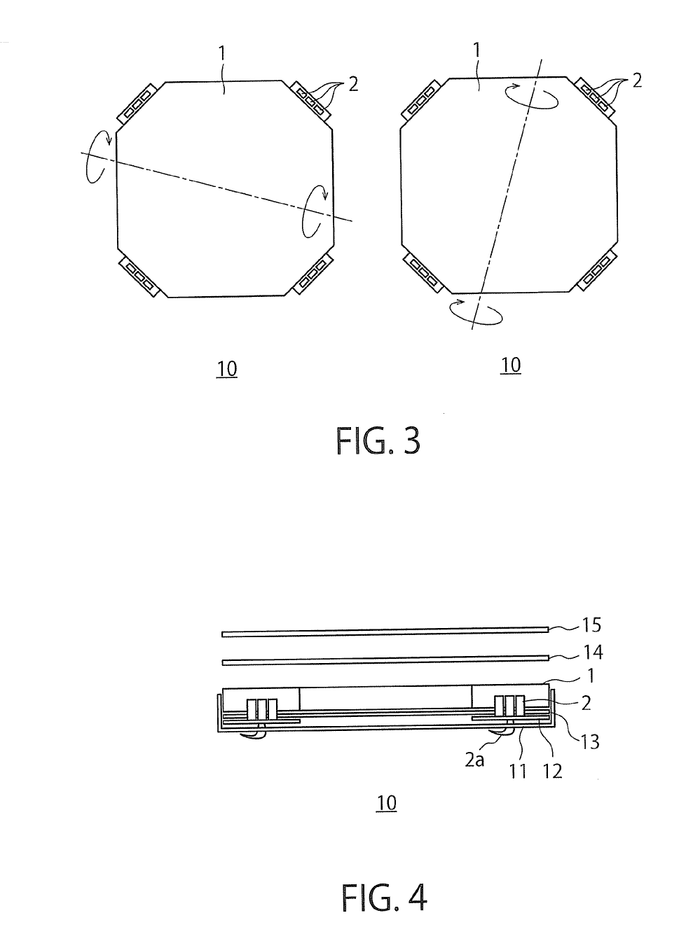

FIGS. 2 and 3 each is an explanatory view explaining bending flexibility of the lighting apparatus 10. The present embodiment disposes the LED light source 2 at a position of a corner of the light guide plate 1. Therefore, as illustrated in FIG. 2, the lighting apparatus 10 can be bent either vertically or horizontally. Further, the lighting apparatus 10 can be bent vertically and horizontally at the same time. Furthermore, as illustrated in FIG. 3, the lighting apparatus 10 can be bent obliquely.

If the LED light source 2 is disposed horizontally along a side of the light guide plate 1, the lighting apparatus 10 cannot be bent vertically. Likewise, if the LED light source 2 is disposed vertically along a side of the light guide plate 1, the lighting apparatus 10 cannot be bent horizontally.

In contrast to this, the present embodiment disposes the LED light source 2 in a corner of the light guide plate 1. Therefore, the lighting apparatus 10 that is flexible and has a high bending flexibility can be obtained.

FIG. 4 is a side view as viewed from the side of the lighting apparatus 10. In addition to the above described light guide plate 1 and LED light source 2, the lighting apparatus 10 includes a light source case 11, an LED bar 12, a reflective sheet 13, a luminance control sheet 14, and an optical sheet 15.

The light source case 11 is made of a flexible material. Then, the LED bar 12, the reflective sheet 13, the light guide plate 1, the luminance control sheet 14, and the optical sheet 15 are laminated in this order inside the light source case 11. The end portion of each side of the optical sheet 15 and the inner side wall of the light source case 11 are sealed with a tape.

The tape may be a colored tape according to the application or may be a tape for optical applications with high transparency. In addition, the light source case 11 may be made of a transparent material according to the application or may be made of a white material to increase the use efficiency of light from the LED light source 2. Alternatively, the entire light source case 11 or the inner side wall thereof may be painted white.

In addition, a wiring hole (unillustrated) is formed on a rear surface of the light source case 11, and a power supply line 2a of the LED 2 is drawn to outside. Thus, the power supply line 2a is drawn out not from the side surface of the lighting apparatus 10 but from the rear surface thereof. As a result, the bezel for hiding the power supply line 2a behind the outer periphery of the lighting apparatus 10 can be formed very thin (or eliminated).

The LED light source 2 is fixed to the LED bar 12 as a board. Then, the LED bar 12 is fixed to the light source case 11 using a screw or a double-sided tape so that light from the LED light source 2 is incident on an edge of the light guide plate 1. More specifically, if the LED light source 2 is of a side-view type, as illustrated in FIG. 4, the LED bar 12 is fixed horizontally to the light source case 11. In contrast to this, if the LED light source 2 is of a top-view type, the LED bar 12 is fixed perpendicularly to the light source case 11.

In order to suppress a hot spot from occurring near the light source of the light guide plate 1, a lens may be disposed in front of the LED light source 2, or a seal on whose surface a prism is formed may be attached to an end surface on which a light beam of the light guide plate 1 is incident.

The reflective sheet 13 is disposed on a bottom surface of the light guide plate 1. Then, the reflective sheet 13 reflects light emitted from the light guide plate 1 to the rear surface back toward the light guide plate 1, which enhances the light use efficiency.

The light guide plate 1 guides the light emitted from the LED light source 2 and light reflected by the reflective sheet 13 upward.

The luminance control sheet 14 is obtained, for example, by silk-printing a reflection pattern or a scattering pattern on the rear surface of a PET (Polyethylene Terephthalate) sheet with an ink that is white and has a high reflectance. The luminance control sheet 14 reduces brightness unevenness due to leakage light around the LED light source 2.

The optical sheet 15 includes a dual brightness enhancement film (DBEF), a brightness enhancement film (BEF), a diffusion sheet, and the like. Micro holes may be provided in the diffusion sheet by dot printing to scatter leakage light emitted directly above from the LED light source 2.

Note that in order to reduce cost, the reflection pattern or the scattering pattern may be printed on the rear surface of the diffusion sheet contained in the optical sheet 15 thereby to integrate the luminance control sheet 14 and the optical sheet 15.

Note also that two or more light guide plates 1 may be incorporated into the light source case 11, which can increase the number of LED bars 12 as much as possible.

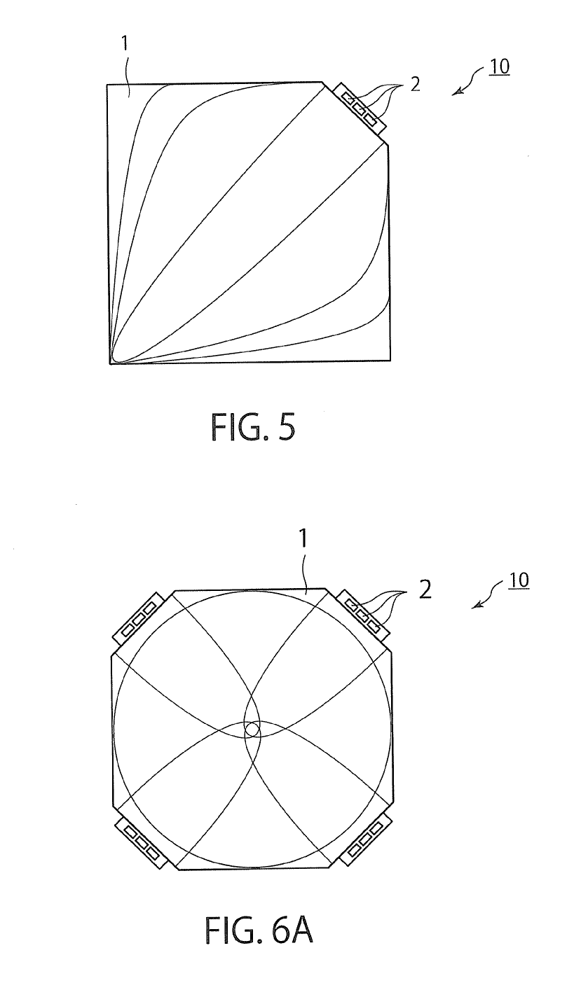

FIG. 5 is an explanatory view explaining the energy of light emitted by an LED light source 2. The Figure illustrates an example in which the light guide plate 1 has a rectangular shape with one corner chipped, and the LED light source 2 is disposed in one place. In this case, the LED light source 2 may emit light with energy allowing the light emitted from the LED light source 2 to be maintained until the light reaches the diagonal corner on the light guide plate 1.

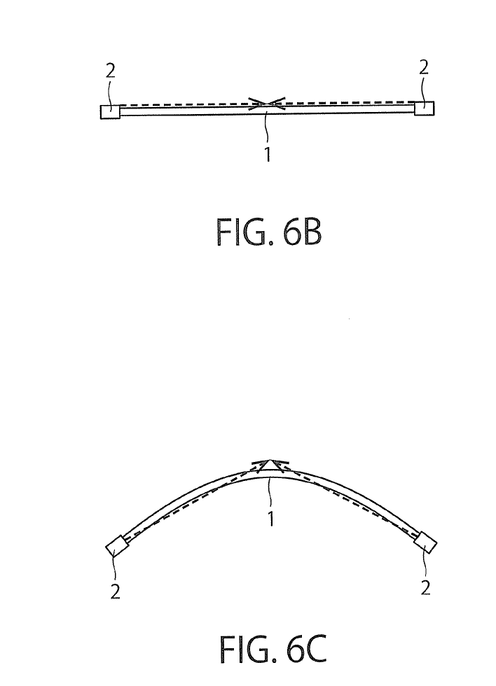

FIGS. 6A to 6C each are an explanatory view explaining the energy of light emitted by an LED light source 2. FIGS. 6A to 6C each illustrate an example in which the light guide plate 1 has a square shape with four corners chipped, and the LED light source 2 is disposed in the four corners. FIG. 6A is a view as seen from above of the lighting apparatus 10. FIGS. 6B and 6C each are a view as seen from the side of the state in which the lighting apparatus 10 is not bent and the state in which the lighting apparatus 10 is bent respectively.

In this case, the scattering pattern is printed so that the energy of light emitted from the LED light source 2 is completely consumed near the center. Thus, the light emitted from the LED light source 2 reaches near the center of the light guide plate 1, but very few light reaches beyond that. The energy of light is almost completely consumed at an inflection point of the center, which can suppress brightness unevenness from occurring due to a light beam emitted from the light guide plate 1 without satisfying the total reflection conditions from near the inflection point when the lighting apparatus 10 is bent.

As described above, the first embodiment includes the light guide plate 1 having a shape with a chipped corner, and disposes the LED light source 2 in the chipped corner. Therefore, the bending flexibility of the lighting apparatus 10 can be increased.

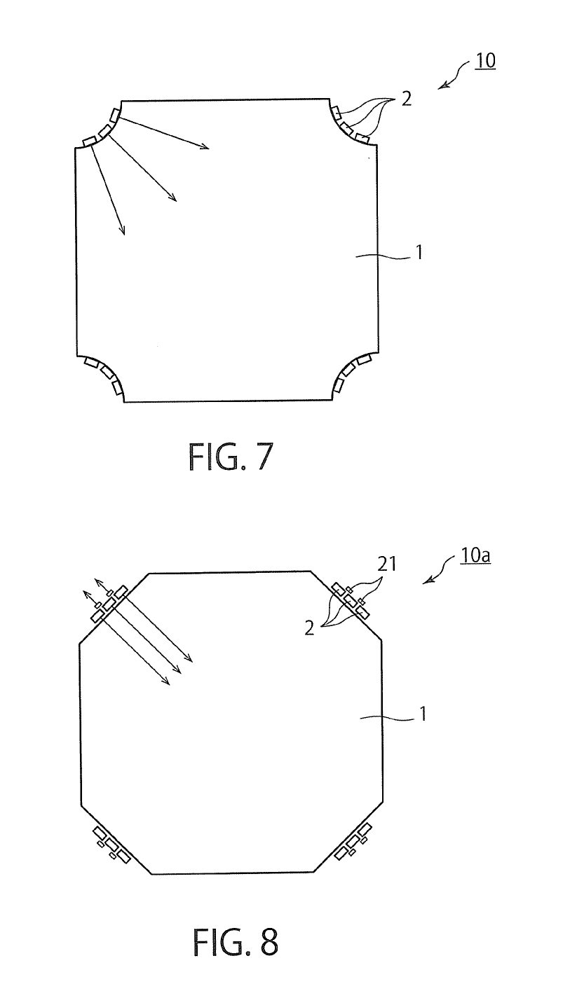

Note that FIG. 1 exemplifies the light guide plate 1 having a shape with the rectangular corners cut in a straight line. In contrast to this, as illustrated by a modification in FIG. 7, the light guide plate 1 may have a shape with the rectangular corners cut in an arc shape. Thus, the light from the LED light source 2 is uniformly diffused concentrically inside the light guide plate 1.

### Second Embodiment

In the above described first embodiment, the brightness in the back of the LED light source 2 may be reduced. However, the reduction in brightness in the back of the LED light source 2 needs to be suppressed depending on the application of the lighting apparatus. In light of this, there follows a description of the second embodiment for suppressing the reduction in brightness in the back of the LED light source 2.

FIG. 8 is a plan view as seen from above of a main portion of a lighting apparatus 10a according to the second embodiment. The lighting apparatus 10 includes an LED light source (second light source) 21 in addition to the LED light source 2. The LED light source 21 is an ultra-small sub LED, and the irradiation amount thereof is less than the irradiation amount of the LED light source 2. The LED light source 21 is disposed behind the LED light source 2 and emits light in a direction opposite to that of the light guide plate 1, namely, in a direction opposite to the light irradiation direction of the LED light source 2, whereby the back of the LED light source 2 can be illuminated.

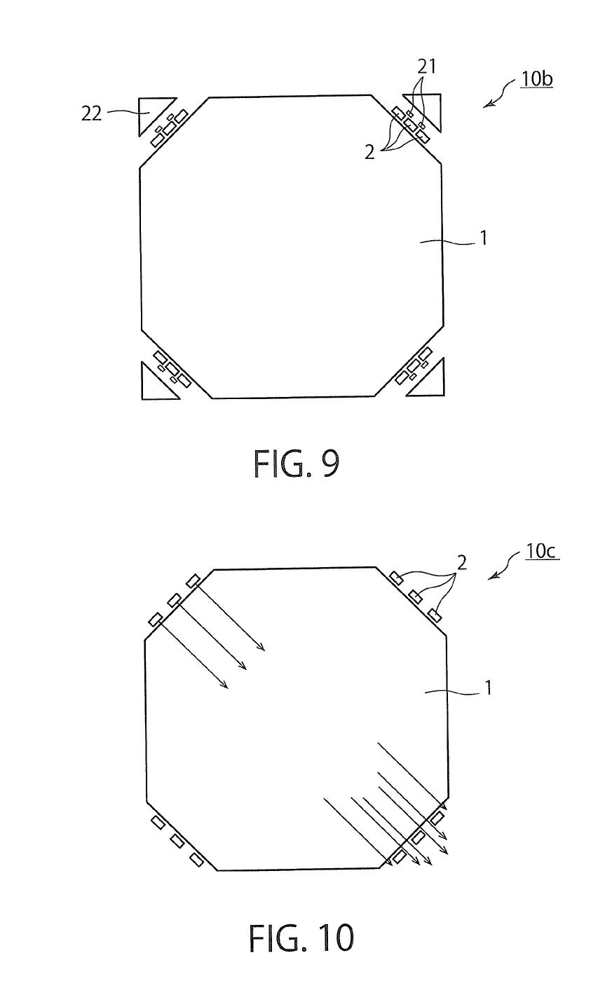

Further, as illustrated by the lighting apparatus 10b in FIG. 9, a light guide plate (second light guide member) 22 of a triangular prism may be disposed in an irradiation direction of the LED light source 21. The light guide plate 22 is desirably flexible too. The light from the LED light source 21 is incident on the light guide plate 22 and is spread within the light guide plate 22. Then, the light is emitted from an upper surface of the light guide plate 22, which can suppress the reduction in brightness (brightness unevenness) in the back of the LED light source 2.

As another example, as illustrated by the lighting apparatus 10c in FIG. 10, the LED light source 2 may be provided with a space. The light emitted from the LED light source 2 passes through between the LED light sources 2 in the diagonal corners and illuminates the rear surface thereof. In this case, the scattering pattern may be printed so that the light emitted from the LED light source 2 is maintained until the light reaches the diagonal corners without being consumed at the center of the light guide plate 1. This configuration can easily suppress the reduction in brightness in the back of the LED light source 2 without the need to use an additional LED light source, and thus is useful particularly when the lighting apparatus 10c is not bent so much. Note that if the LED light source 2 is of a top-view type, the LED bar 12 is configured using a transparent board so as to prevent the LED bar 12 from blocking the light.

As described above, the second embodiment can suppress the reduction in brightness in the back of the LED light source 2.

By the way, an OLED is known as the flexible lighting apparatus. The description will focus on the advantage of the lighting apparatus according to the present embodiment using an LED as the light source in comparison with the OLED.

In general, the OLED has a low brightness and light-emitting efficiency as well as a short life. In contrast to this, the present embodiment can increase the brightness and light-emitting efficiency as well as life using the LED light source.

In addition, the OLED manufacturing technique has not been established, and thus the OLED manufacturing cost is high and the yield is low. In contrast to this, the present embodiment can manufacture the LED light source in a stable manner using an established manufacturing technique. As a result, the lighting apparatus manufacturing cost can be suppressed.

Further, it is difficult to increase the size of the OLED. When the size of the OLED is to be increased by tiling, joints become noticeable at tiling because the outer periphery of the OLED includes a non-light emitting region of about 5 to 10 mm. In contrast to this, the present embodiment can greatly reduce the thickness of the bezel (or eliminate the bezel) by drawing the power supply line 2a of the LED light source from the rear surface. As a result, the present embodiment can prevent the joints from being noticeable at tiling.

In addition, the present embodiment can exhibits high color rendering properties comparable to the OLED using the LED light source emitting light of each wavelength of RGB.

Various applications can be considered for each lighting apparatus described above.

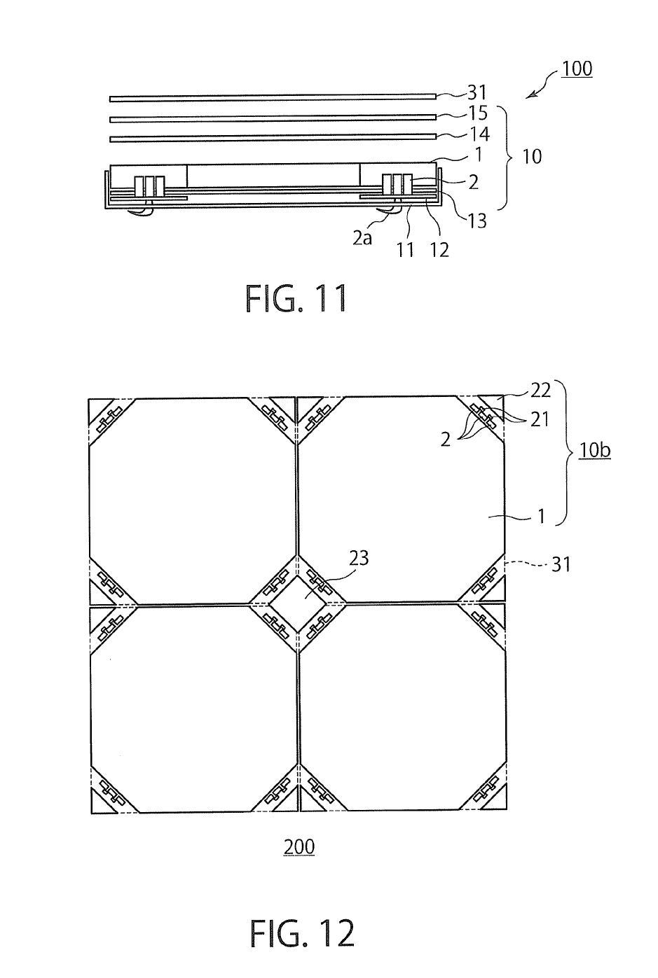

FIG. 11 is a side view as viewed from the side of a liquid crystal display apparatus 100 using the lighting apparatus 10. As illustrated in the Figure, the liquid crystal display apparatus 100 includes a liquid crystal display panel 31 and the lighting apparatus 10 as the backlight unit. The lighting apparatus 10 is disposed opposite to the liquid crystal display panel 31. Then, the light guide plate 11 in the lighting apparatus 10 guides the light emitted from the LED light source 2 to the liquid crystal display panel 31. The light allows an image to be displayed on the liquid crystal display panel 31.

The liquid crystal display panel 31 is also flexible and can be bent vertically and horizontally at the same time as illustrated in FIG. 2. Further, as illustrated in FIG. 3, the liquid crystal display panel 31 can also be bent obliquely.

Note that the liquid crystal display apparatus may be configured to include any one of the lighting apparatuses 10a to 10c.

Such a liquid crystal display apparatus 100 can be used by bending so as to surround the viewer. Thus, the field of view of the viewer is covered with the liquid crystal display apparatus 100, which improves reality of the image displayed. In particular, the liquid crystal display apparatus 100 can be considered applicable to an arcade game device such as a shooting game.

FIG. 12 is a plan view as seen from above of a main portion of a display system 200 configured to tile a plurality of lighting apparatuses 10b and liquid crystal display panels 31. As described using FIG. 4, the power supply line 2a of the LED light source 2 is drawn from the rear surface of the lighting apparatus 10b. This configuration eliminates the need to provide a bezel on an outer periphery of the lighting apparatus 10b and the liquid crystal display panel 31, and can greatly reduce the thickness of the joints between the liquid crystal display panels 31.

Note that the corners of the lighting apparatuses 10b are positioned at the center of the display system 200. Therefore, the lighting apparatus 10b capable of suppressing the reduction in brightness at the center is desirably used. Then, instead of the light guide plate 22 of the triangular prism, a square-shaped flexible light guide plate 23 may be disposed at the center of the display system 200. In order to enhance the light use efficiency, a white reflective tape is desirably attached to the side surface of the light source case 11.

In addition to the above, the lighting apparatus can be considered applicable to a curved surface such as being wrapped around a cylindrical pillar or attached to the ceiling of a car.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fail within the scope and spirit of the inventions.

1. A lighting apparatus comprising:
a flexible first light guide member having a rectangular shape with at least one corner chipped; and
a first light source disposed at a position of a chipped corner of the first light guide member and configured to emit light to the first light guide member.

2. The lighting apparatus of claim 1, wherein
the first light guide member includes a first side and a second side opposite to each other as well as a third side and a fourth side opposite to each other and has a rectangular shape with at least one corner chipped, and
the first light guide member is bendable in a direction parallel to the first side and bendable in a direction parallel to the third side.

3. The lighting apparatus of claim 1, wherein
the first light guide member has a rectangular shape with four corners chipped, and
the first light source is disposed at a position of each chipped corner of the first light guide member.

4. The lighting apparatus of claim 3, wherein light emitted from the first light source reaches substantially a center of the first light guide member.

5. The lighting apparatus of claim 4, wherein the light emitted from the first light source does not reach beyond substantially the center of the first light guide member.

6. The lighting apparatus of claim 1, wherein a power supply line of the first light source is drawn from a rear surface of the lighting apparatus.

7. The lighting apparatus of claim 1, wherein the first light guide member has a rectangular shape with at least one corner cut in an arc shape.

8. The lighting apparatus of claim 1, further comprising a second light source disposed at a position of a chipped corner of the first light guide member and configured to emit light in a direction opposite to a direction in which the first light source emits light.

9. The lighting apparatus of claim 8, further comprising a second light guide member disposed at a position of a chipped corner of the first light guide member and configured to be irradiated with light from the second light source.

10. The lighting apparatus of claim 1, wherein the first light source is an LED light source.

11. A display apparatus comprising:
a flexible display panel;
a flexible first light guide member disposed opposite to the display panel and having a rectangular shape with at least one corner chipped; and
a first light source disposed at a position of the chipped corner of the first light guide member and configured to emit light to the first light guide member, wherein
the first light guide member guides the light emitted from the first light source to the display panel.

12. The display apparatus of claim 11, wherein
the first light guide member includes a first side and a second side opposite to each other as well as a third side and a fourth side opposite to each other and has a rectangular shape with at least one corner chipped, and
the display panel and the first light guide member is bendable in a direction parallel to the first side and is bendable in a direction parallel to the third side.

13. The display apparatus of claim 11, wherein
the first light guide member has a rectangular shape with four corners chipped, and
the first light source is disposed at a position of each chipped corner of the first light guide member.

14. The display apparatus of claim 13, wherein light emitted from the first light source reaches substantially a center of the first light guide member.

15. The display apparatus of claim 14, wherein the light emitted from the first light source does not reach beyond substantially the center of the first light guide member.

16. The display apparatus of claim 11, wherein a power supply line of the first light source is drawn from a rear surface of the lighting apparatus.

17. The display apparatus of claim 11, wherein the first light guide member has a rectangular shape with at least one corner cut in an arc shape.

18. The display apparatus of claim 11, further comprising a second light source disposed at a position of a chipped corner of the first light guide member and configured to emit light in a direction opposite to a direction in which the first light source emits light.

19. The display apparatus of claim 18, further comprising a second light guide member disposed at a position of a chipped corner of the first light guide member and configured to be irradiated with light from the second light source, wherein
the second light guide member guides the light emitted from the second light source to the display panel.

20. The display apparatus of claim 11, wherein the first light source is an LED light source.
